(19) United States
(12) Patent Application Publication
(10) Pub. No.: US 2026/0027600 A1
(43) Pub. Date: Jan. 29, 2026

(54) OIL TANK PREPARATION MODULE

(71) Applicant: BLACK GOLD COMPRESSION SERVICE, LLC, Carlsbad, NM (US)

(72) Inventor: Jeffery Thomas Enloe, Carlsbad, NM (US)

(73) Assignee: BLACK GOLD COMPRESSION SERVICE, LLC, Carlsbad, NM (US)

(21) Appl. No.: 19/233,572

(22) Filed: Jun. 10, 2025

Related U.S. Application Data
(60) Provisional application No. 63/675,861, filed on Jul. 26, 2024.

(51) Int. Cl. B08B 9/08

(52) U.S. Cl. CPC B08B 9/0813; B08B 2209/08

(57) ABSTRACT

Apparatus and associated methods relate to an automatic oil tank preparation module, a device designed to efficiently manage the separation and retention of water and oil within storage tanks. Storage tanks may, for example, include oil barrels. The oil tank preparation module may, for example, utilize a buoyant valve mechanism that responds dynamically to fluid levels, allowing for selective water release while retaining oil. The buoyant valve, for example, is engineered to float on water but sink under oil, activating or deactivating flow based on the relative levels of these liquids. Various embodiments may advantageously optimize storage conditions and prevent water contamination of the oil supply.

### TECHNICAL FIELD

Various embodiments relate generally to the transportation of oil and gas and energy industry.

### BACKGROUND

The transportation of oil and gas relies heavily on the use of barrels as a standard unit of measure, which plays a central role in logistics and international trade. Each barrel, holding 42 U.S. gallons, is a key metric for transporting these resources via pipelines and ships. Pipelines transport vast quantities daily and are equipped with advanced systems to ensure safe and efficient delivery. Similarly, large tanker ships traverse global routes carrying hundreds of thousands of barrels, employing technologies designed to minimize environmental risks and enhance safety. This widespread use of barrels standardizes global trade and supports the strategic distribution of energy resources, ensuring steady supplies to meet domestic & international demand.

### SUMMARY

Apparatus and associated methods relate to an automatic oil tank preparation module, a device designed to efficiently manage the separation and retention of water and oil within storage tanks. Storage tanks may, for example, include oil barrels. The oil tank preparation module may, for example, utilize a buoyant valve mechanism that responds dynamically to fluid levels, allowing for selective water release while retaining oil. The buoyant valve, for example, is engineered to float on water but sink under oil, activating or deactivating flow based on the relative levels of these liquids. Various embodiments may advantageously optimize storage conditions and prevent water contamination of the oil supply.

Various embodiments may achieve one or more advantages. For example, some embodiments ensure the integrity of oil quality over extended periods, thereby preventing potential rejection of loads during pick-up due to contamination. Additionally, by maintaining a cleaner separation between oil and water, these systems may reduce the costs associated with additional processing and treatment of stored oil. Furthermore, the precise control of the valve mechanism may enhance operational efficiency, allowing for more predictable and managed fluid handling. This may lead to improved safety standards and less environmental impact, as the risk of accidental oil spills is minimized.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary oil tank preparation module employed in an illustrative use-case scenario.

FIG. 2 depicts an exemplary oil tank preparation module buoyant ball valve configuration.

FIG. 3A depicts an exemplary oil tank preparation module buoyant ball valve configuration.

FIG. 3B depicts an exemplary oil tank preparation module buoyant ball valve embodiment.

FIG. 4 depicts an illustrative method of operation of an exemplary oil tank preparation module.

FIG. 5 depicts an exemplary oil tank preparation module employed in an illustrative use-case scenario.

Like reference symbols in the various drawings indicate like elements.

### DETAILED DESCRIPTION OF ILLUSTRATIVE EMBODIMENTS

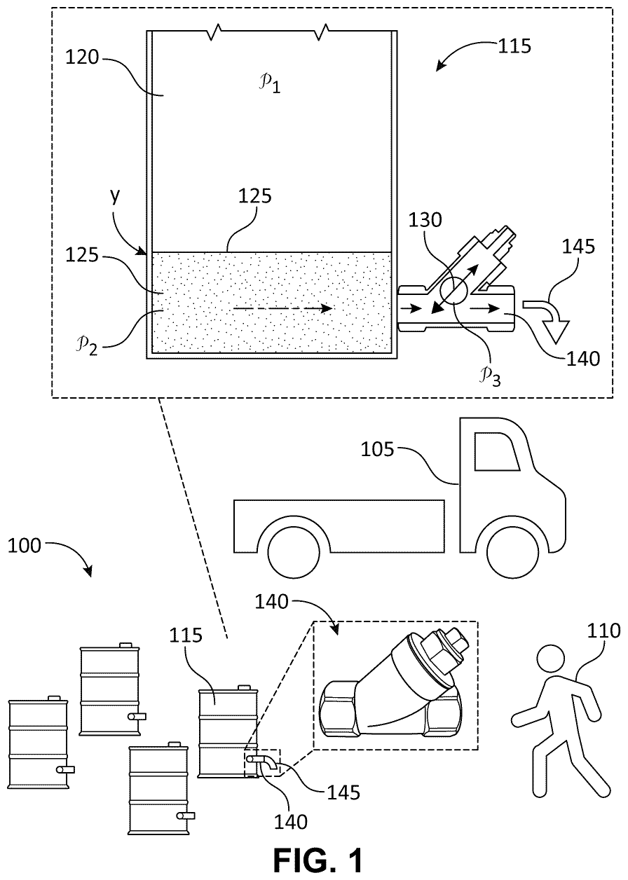

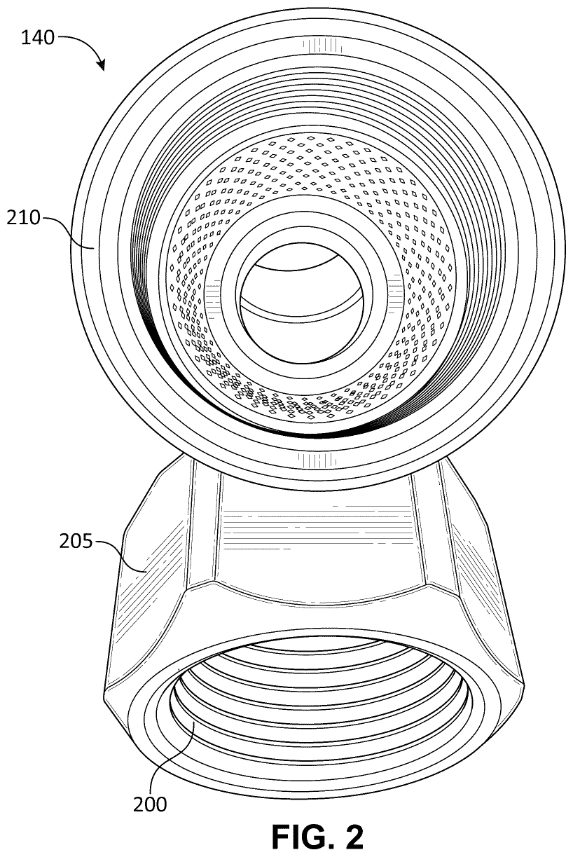

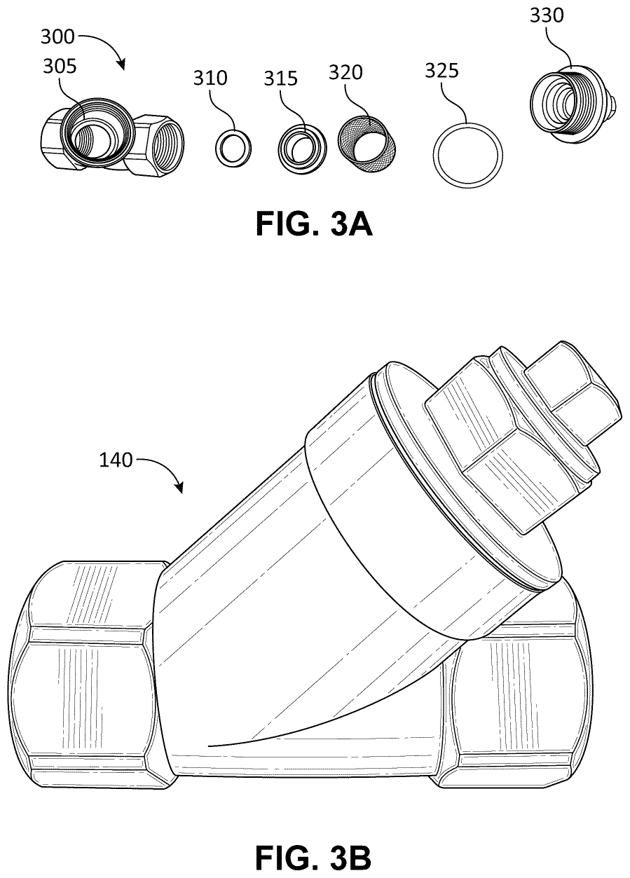

To aid understanding, this document is organized as follows. First, to help introduce discussion of various embodiments, an oil tank preparation module is introduced with reference to FIGS. 1. Second, that introduction leads into a description with reference to FIGS. 2-3B of some exemplary embodiments of the buoyant ball oil tank preparation module embodiment.

FIG. 1 depicts an exemplary oil tank preparation module employed in an illustrative use-case scenario 100. The illustrative use-case scenario 100 includes a fuel pick up vehicle 105. The illustrative use-case scenario 100 includes an inspector 110. The inspector is checking whether the fuel tanks 115 meet a predetermined standard.

The predetermined standard may, for example, include less than 4% dirty water. The predetermined standard may, for example, include 8% dirty water. The illustrative use-case scenario 100 includes some fuel tanks 115. The fuel tanks 115 are being inspected.

For context, a fuel tank may, for example, fail inspection if it contains too much dirty water. Dirty water may, for example, accumulate as water seeps out of the crude oil, as the oil and water separates. As such the dirty water % may, for example, over time increase in the fuel tank. The fuel tank may, for example, be in some modes as a closed container.

The fuel tanks 115 contain crude oil 120. As crude oil sits, water may, for example, begin to seep to the bottom of the fuel tank. Oil may, for example, oil float to the top, because oil has a lower density than water. The oil may, for example, slowly separate the water from its composition, such that the oil slowly changes its percentage mixtures of water and oil over time, resulting in a change in density. The change in density of these mixtures may, for example, cause an internal flow within the fuel tank.

Higher percentage compositions of oil may, for example, transition to the top. Higher percentage compositions of water may, for example, transition to the bottom. The fuel tanks 115 contains dirty water 125. The border 125a of the dirty water 125 and the remaining crude oil is depicted. The dirty water and remaining crude oil may, for example, have different densities.

Water may, for example, have a higher density oil, so it sinks to the bottom of the mixture.

The fuel tanks 115 has a water release mode. In a water release mode, the water level 125a exceeds a predetermined height at the bottom of the barrel (e.g., because water sinks to bottom because it is less dense than oil). As the water level exceeds a predetermined height (e.g., a predetermined dirty water ratio), the water is release in a stream 145. The water stream 145 is released through a valve 140. The valve 140 includes a buoyant object 130. The valve may, for example, include a filter configured to receive any contaminants prior to releasing the water stream.

The oil preparation valve module may, for example, be modeled. The oil preparation valve module analysis may, for example, be modeled with a cartesian system of a bisection of the fuel storage container using an x-y system.

The pressure in the fuel tank at the y0, height may, for example, be constant while in a storage mode. The location of y0 may, for example, be place at the entrance of the valve. The water level (e.g., the border between the oil and the water) may, for example, be modeled as y.

As the fluid composition changes, in the valve as the water level rises (e.g., transitions from water to oil), the buoyant object may, for example, begin to float along a predetermined path. The water dispersing mode may, for example, start when the water level rises more than a predetermined height. The buoyant object may, for example, lift slightly to only let a partial fluid flow through the valve. The predetermined path the buoyant object transverses may, for example, be determined by the valves structure. The pressure in the fuel tank may, for example, then be released as fluid flow, decreasing the internal pressure of the container. The initial velocity of the fluid stream may, for example, be modeled via Bernoulli's equation. The fluid velocity as it passes through the ball valve configuration may, for example, throttle, as in a nozzle model. The fluid velocity may, for example, in those cases increase, as the change of cross-sectional area of the fluid changes from the entrance of the valve to the exit to travel underneath the ball. The fluid flow may, for example, diffuse as it enters a greater cross-sectional area after leaving underneath the buoyant object (e.g., ball). In some embodiments the buoyant object may, for example, be a translating object. The buoyant object may, for example, be replaced with a translating object, if sensors may, for example, be placed in the storage container to facilitate the verification process that the fluid being released is dirty water. A sensor may, for example, be employed to verify this, and a switch valve may, for example, be used to let fluid flow.

The pressure p_y may, for example, be determined by taking the addition of a first exemplary product of the first fluid's density (e.g., oil), the gravitational constant, and the volume of the first fluid (e.g., remaining fluid amount of the same density) and a second exemplary product of the second fluid's density (e.g., water), the gravitational constant, and the volume of water total, subtracting the height of the fluid below the borderline.

The buoyant object, in some embodiments as depicted in FIG. 1, may, for example, be oriented in the valve such that it may translate in a sloped direction based on a predetermined angle, theta. The angle may, for example, be 60 degrees. The angle in some embodiments, may, for example, be 45 degrees. The angle in some embodiments, may, for example, 30 degrees. The buoyant object may, for example, have a weight. The object may, for example, have a weight force along the axis of the slope of the angle of cos(theta). The object may, for example, have a weight force perpendicular to the axis of the slope of sin(theta). The force perpendicular may, for example, equal the reaction force in some cases. In other cases, as the ball rises due to the buoyant forces caused by the displaced volume of water, the reactionary forces may, for example, change. The provided sketch describing the angular relationship to weight may, for example, also change based on the external forces affecting the balls orientation. In some embodiments, the buoyant object may, for example, be fixed to a predetermined path. The fixed predetermined path may, for example, be modeled such that there is a reactionary force from the top and bottom locking the ball in place, so that it can only translationally slide, and/or roll along the predetermined path to allow for fluid flow through beneath the buoyant object after the internal water level reaches a predetermined height.

In a storage mode the fuel tank may, for example, not dispense oil. The valve which may, for example, be because the object buoyant object is obstructing valve such that the fluids in the fuel tank are unable to translate the internal pressure into a fluid flow stream.

As the fluid composition changes, in the valve as the water level rises from the bottom, the buoyant object may, for example, begin to float. The pressure in the fuel tank may, for example, then be released as fluid flow, decreasing the internal pressure of the container.

The weight of the ball may, for example, be configured to equal the buoyance forces associated with oil. The ball may, for example, remain static when displacing oil. The ball may, for example, translate along the predetermined path upward when displacing dirty water. Dirty water may, for example, be denser than non-dirty water. Dirty water may, for example, be less dense than dirty water. Dirty water's density may, for example, vary depending on its composition (e.g., mixture of oil and water, mixture of dirt and water, pure water).

In some embodiments, the valve, may, for example, incorporate a spring. The spring may, for example, be incorporated in the sloped valve embodiment. In a dispersing mode 116a, the buoyant object 130 is coupled to a cord 135. The cord 135 is coupled to the valve. After the dirty water is released, the buoyant object will sink with the water level 125 a, as depicted in a blockage mode 116b. After reaching a water level 125b, the height of the buoyant stowage area in the valve, the water's release will stop. After the flow stops, the fuel tank enters stowage mode 116b, wherein no water is released. Water may, for example, be released later, if too much time has passed and the water level rises. Eventually, the fuel tank may, for example, eventually stop releasing water, after the water and fuel has completely separated from each other. The predetermined height may, for example, be 4 inches from the ground. The predetermined height may, for example, be 2 inches from the ground.

FIG. 2 depicts an exemplary oil tank preparation module buoyant ball valve 140 configuration. The valve 140 includes a channel configured for fluid flow along an horizontal axis 205. The valve 140 includes an exit channel 200, wherein additional fluid flow caps and/or hoses may, for example, be coupled. In some embodiments, the excess dirty water may, for example, be transported via pipe to a dirty water container. The valve 140 includes a buoyant object angle channel 210, extending along a predetermined path a predetermined angle, theta.

FIG. 3A depicts an exemplary oil tank preparation module buoyant ball valve configuration 300. The module buoyant ball valve configuration 300 includes angled channel 305. The angled channel 305 may, for example, receive a washer 310. The angled channel 305 may, for example, receive an internal ball/fluid inlet 315. The angled channel 305 may, for example, include a wiring 320, (e.g., a cylinder) configured to receive the ball internally. The angled channel 305 may, for example, include a washer 325 configured for the wiring channel 320. The angle channel may, for example, be sealed with a cap 330. FIG. 3B depicts an assembled exemplary oil tank preparation module buoyant ball valve embodiment.

In some embodiments, the oil tank preparation module may, for example, rely on purely mechanical components to function, eliminating the need for electronic controls. The oil tank preparation module may, for example, enhance durability and reduce maintenance requirements in harsh environments. The oil tank preparation module may, for example, utilize a mechanical float system that operates valves based on the oil-water interface, ensuring efficient separation without the use of sensors or electronic feedback. The oil tank preparation module may, for example, employ manual gauges to monitor the levels and quality of oil, promoting ease of use and reliability. The oil tank preparation module may, for example, make it particularly suitable for remote locations where electronic repairs are not feasible.

In some embodiments, the oil tank preparation module may, for example, incorporate mechanical timers and pressure-driven valves to regulate the release of water accumulated during the oil storage process. The oil tank preparation module may, for example, feature a pressure balance system that automatically initiates the release of water when certain pressure thresholds are exceeded, preventing contamination. The oil tank preparation module may, for example, use gravity-fed channels that guide the separated water to collection areas, relying on natural forces rather than powered mechanisms.

In some embodiments, the oil tank preparation module may, for example, use a series of manually adjustable baffles to control the flow and separation of oil and water within the tank. These baffles in the oil tank preparation module may, for example, be shifted to accommodate different types of crude oil, altering the flow dynamics to optimize separation efficiency based on specific gravity and viscosity. This manual adjustment capability by the oil tank preparation module may, for example, allow operators to customize the process. Additionally, the oil tank preparation module may, for example, incorporate a pump system to assist in the removal of collected water, enhancing control over the separation process.

In some embodiments, the oil tank preparation module may, for example, be designed with a manual override system that allows operators to control the separation process directly. This feature of the oil tank preparation module may, for example, provide an added layer of reliability, ensuring that operations can continue even if other mechanical systems fail. The manual controls on the oil tank preparation module may, for example, include levers, gears, and valves that can be operated by hand, offering precise control over the flow and processing of oil. This hands-on approach by the oil tank preparation module may, for example, be particularly valued in applications where fine adjustments are necessary to achieve optimal separation results, ensuring high-quality oil output without the complexities and vulnerabilities of electronic systems.

In some embodiments, the oil tank preparation module may, for example, integrate a series of sensors to detect the presence of contaminants such as water and sediments at various levels of the storage tank. The oil tank preparation module may, for example, utilize a layered filtration system that progressively purifies the oil as it passes through each stage. This may help in maintaining the quality of oil over extended storage periods. The oil tank preparation module may, for example, be equipped with automated software that adjusts the filtration process based on the oil's condition. This proactive approach by the oil tank preparation module may, for example, ensure optimal operations without manual intervention, and provide visual indicators of status.

In some embodiments, the oil tank preparation module may, for example, operate in conjunction with existing pipeline systems to enhance efficiency in oil transportation. The oil tank preparation module may, for example, be installed at strategic points along the pipeline to periodically condition the oil before it reaches its final destination. This may prevent the buildup of contaminants that can degrade the oil during transit. The oil tank preparation module may, for example, include redundancy systems to maintain operation during routine maintenance, thereby preventing downtime.

In some embodiments, the oil tank preparation module may, for example, be adapted for offshore oil platforms where space and environmental conditions impose unique challenges. The oil tank preparation module may, for example, be constructed from corrosion-resistant materials to withstand harsh marine environments. This may prolong the operational life and reduce maintenance needs. The oil tank preparation module may, for example, feature a compact design to optimize the limited space available on platforms. The system's efficiency by the oil tank preparation module may, for example, be enhanced through the integration of real-time data analytics to monitor and adjust the separation process based on specific sea conditions. The oil tank preparation module may, for example, include emergency shut-off capabilities to mitigate spills, enhancing environmental protection.

In some embodiments, the oil tank preparation module may, for example, be configured for mobile deployment to service remote or temporary drilling sites. The oil tank preparation module may, for example, come with modular components that may be assembled and disassembled as needed, providing flexibility in operations. In some oil tank preparation module embodiments that include electronics may, for example, incorporate solar panels to reduce reliance on external power sources, making it ideal for environmentally sensitive areas. A centralized control system and network may, for example, be used to remotely monitor fuel tanks.

In some embodiments, the oil tank preparation module may, for example, be designed with an emphasis on safety to protect both personnel and the environment. The oil tank preparation module may, for example, include multiple fail-safes, such as overflow sensors and automatic shut-off valves, to prevent spills. These safety features of the oil tank preparation module may, for example, be important in regions with stringent environmental regulations. The oil tank preparation module may, for example, incorporate flame retardant materials and explosion-proof components to mitigate the risks associated with volatile oil vapors. The safety protocols implemented by the oil tank preparation module may, for example, ensure compliance with international safety standards and enhance the credibility and reliability of the operations.

In some embodiments, the oil tank preparation module may, for example, include customization options to cater to various types of crude oil, acknowledging that different oils require different handling techniques. The oil tank preparation module may, for example, be equipped with adjustable settings to modify the separation intensity based on the specific gravity and viscosity of the oil being processed. This adaptability of the oil tank preparation module may, for example, ensure optimal performance across a wide range of oil types and conditions. Furthermore, the oil tank preparation module may, for example, offer modular upgrades that can be added as needed to enhance functionality or to accommodate changes in operational demands. This scalability by the oil tank preparation module may, for example, be invaluable for companies looking to expand their operations without investing in entirely new systems.

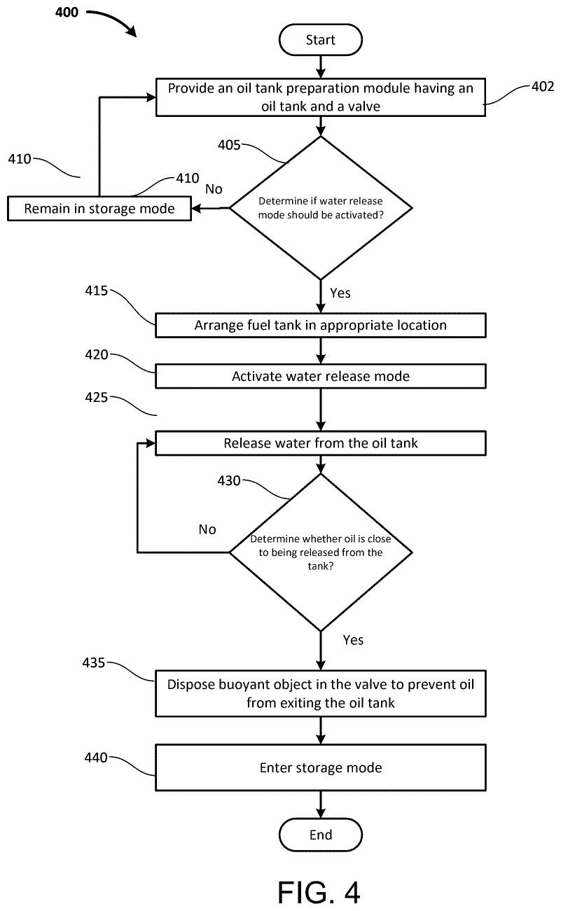

FIG. 4 depicts an illustrative method of operation of an exemplary oil tank preparation module. A method 400 starts with providing, for example, an oil tank preparation module having an oil tank and a valve in step 402. The method 400 then proceeds to a decision point to determine if, for example, the water release mode should be activated in an oil tank preparation module in step 405. If the water release mode should not be activated, then, in some examples, the oil tank preparation module should remain in a storage mode in step 410. If the water release mode should be activated, the fuel tank may, for example, be arranged in an appropriate location in step 415. The water release mode of the oil tank preparation module may, for example, be activated in step 420. Water may, for example, be released from the oil tank in step 425. Another decision point may, for example, be reached to determine whether oil is being released from the tank in step 430. In some examples, if oil is not close to being released from the tank, then the method returns to step 425. If oil is close to being released from the tank, then the method proceeds to step 435. In step 435, the oil tank preparation module may, for example, dispose a buoyant object in the valve to prevent oil from exiting the oil tank. Once the buoyant object is disposed in the valve, the oil tank preparation module enters storage mode in step 440.

In some embodiments, the step of arranging the oil tank in an appropriate location may include positioning the oil tank so the water is drained into a body of water so it can be reused. For example, the oil tank may be drained into a large pool. The pool may, in some examples, store the water drained from the oil tank so it can be reused in other settings.

In various embodiments, the step of disposing a buoyant object in the valve to prevent oil from exiting the oil tank may, for example, be dependent on the amount of water and oil in the tank. As more water is disposed from the tank, the buoyant object may, in some examples, be disposed in the exit valve proportionately. The buoyant object may, for example, be completely disposed in the exit valve before any oil exits the oil tank. This may, for example, advantageously prevent oil from exiting the oil tank.

In some implementations, the valve may be configured to release water, but not oil, from an oil tank, the valve being coupled to an oil tank and a buoyant material via cord, the buoyant material is configured to be displaced as a function of the water and oil levels in the oil tank from a buoyant material channel to an exit channel, wherein the buoyant material channel extends in the direction of the exit channel.

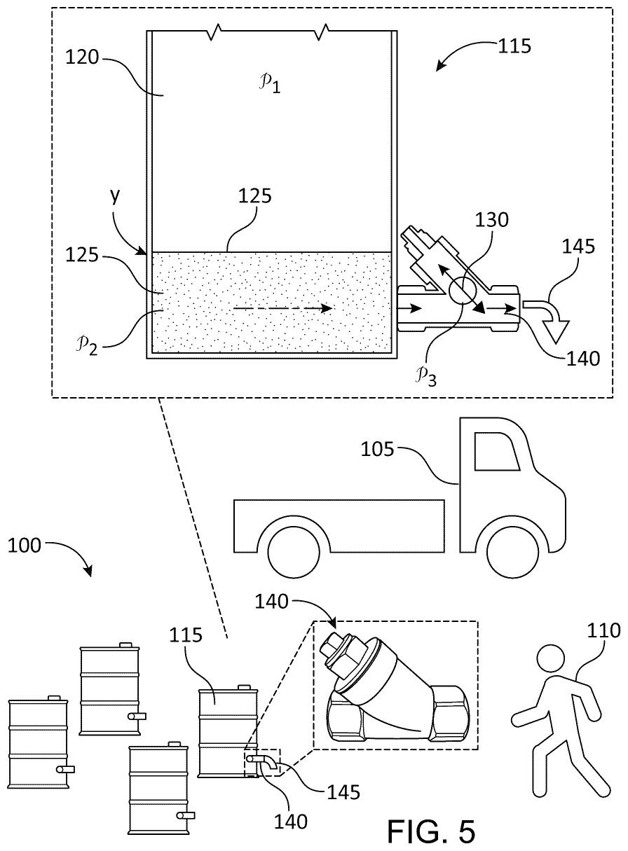

FIG. 5 depicts an exemplary oil tank preparation module employed in an illustrative use-case scenario 500. As depicted in FIG. 5, the angle channel of the valve 140 extends in a direction towards the fuel tank 115. This may, for example, advantageously prevent the pressure of fluid flowing from the fuel tank 115 to the exit channel from affecting the disposal of the buoyant object 130 into the exit channel.

In some embodiments, the valve 140 may be reversibly attachable to the fuel tank 115. This may, for example, advantageously enable the fuel tanks 115 to be stored ergonomically in transit without risking damage to the valves 140. The valves 140 may, for example, be reversibly attached when fluid in the fuel tank 115 is being separated. In some embodiments, the valves 140 are configured to mount externally to the fuel tank 115. This may, for example, advantageously enable a single valve to separate the fluid in multiple fuel tanks 115.

In various implementations, the oil tank preparation module includes a conduit arranged on an axis substantially orthogonal to the gravity vector having a proximal inlet connecting to a volume of a fluid to be separated. This may, for example, advantageously limit gravities affect on the flow of fluid through the inlet. The conduit may, in some examples, have a body extending laterally to prevent fluid from the storage tank to flow distally through a seat junction. The body may, in some implementations, extend substantially orthogonal to the gravity vector to prevent flow from an inlet to an outlet. In various implementations, the blocker module housing is configured to receive the blocker module in response to the fluid flow through the body. The blocker module may, for example, be configured to be disposed into the exit valve as the proportions of different fluids change within the oil tank. The blocker module may, in some examples, be configured to be reversibly positioned to the blocker module housing. This may, for example, advantageously prevent the blocker module from being positioned away from the blocker module housing.

In some implementations, the angle of the angle channel may be acute. The angle may, for example, be less than 90 degrees. In various implementations, the buoyant object may be configured to block oil from being released from the fuel tank.

In various aspects, the water stream from the fuel tank is first released into a pipe. The pipe may, for example, extend laterally from the fuel tank. The pipe may, for example, curve and extend downwards towards a valve positioned at the distal end of the pipe. In some examples, the valve may be arranged in parallel with the gravity vector. For example, the angle channel may extend in a direction substantially parallel with the gravity vector. In some aspects, the angle channel may extend at an angle Θ from the exit channel of the valve. This may, for example, advantageously enable the valve to be arranged in a position perpendicular to the gravity vector and a position parallel with the gravity vector.

Although various embodiments have been described with reference to the figures, other embodiments are possible.

Although an exemplary system has been described with reference to FIGS. 1-5, other implementations may be deployed in other industrial, scientific, medical, commercial, and/or residential applications.

In industrial applications, the oil tank preparation module may serve as a component in managing the separation of water and oil within storage facilities. For example, in the petrochemical sector, the oil tank preparation module may ensure that the production process is not affected by water contamination. The oil tank preparation module may include a buoyant valve designed to activate as water levels rise, selectively releasing water without losing valuable oil. This may help maintain the purity and quality of the oil, crucial for consistent industrial processes. The oil tank preparation module may prevent downtime and operational delays by efficiently managing water levels in oil storage tanks. The oil tank preparation module may, for example, lead to substantial cost savings and improved operational efficiency in various industrial settings.

In scientific research applications, the oil tank preparation module may be integral for experiments that require precise hydrocarbon measurements. For example, in environmental studies, maintaining the integrity of oil samples is essential. The oil tank preparation module may provide a reliable mechanism to separate water from oil, ensuring that samples remain uncontaminated. The oil tank preparation module may, for example, facilitate the safe storage of oil by preventing water accumulation, which can lead to degradation of samples. The oil tank preparation module, may, for example, be used to enhance scientific accuracy and reliability in research settings involving oil.

In commercial applications, the oil tank preparation module may, for example, optimize the handling and quality of oil products stored for retail or wholesale markets. For example, in the fuel supply industry, the separation of water from oil may prevent the distribution of contaminated fuel. The oil tank preparation module may include a configured valve that prevents oil loss while allowing water discharge, thereby maintaining fuel quality. The oil tank preparation module may enhance customer satisfaction and reduce the risk of engine damage caused by water in the oil. The oil tank preparation module may, for example, help companies adhere to regulatory standards and avoid penalties. The oil tank preparation module may, for example, be used to maintain profitability and reputation in the competitive oil market.

In residential applications, the oil tank preparation module may, for example, be used in home heating systems that rely on oil. For example, during heavy rain or flooding, water may seep into oil tanks commonly stored underground. The oil tank preparation module may prevent this water from contaminating the heating oil, thus ensuring efficient furnace operation and reducing maintenance costs. By managing the separation of oil and water, the oil tank preparation module may extend the lifespan of residential heating systems and reduce the frequency of service calls. This may provide homeowners with peace of mind and financial savings over time.

In some implementations, the angle channel may defined by a hollow body. The angle channel may, in some examples, extend longitudinally along a predetermined pat at a predetermined angle from an exit channel. The exit channel may, in some aspects, extend longitudinally from a proximal end to an exit aperture at a distal end. In some implementations, the buoyant object may be configured to be reversibly released into the exit channel from the angle channel as a function of the water and oil levels in the oil tank.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated.

What is claimed is:

1. A valve coupled to an tank comprising:
a hollow exit channel extending longitudinally along a predetermined path from a proximal end to an exit aperture at a distal end;
an angle channel extending at a predetermined angle Θ from the exit channel;
the exit channel being fluidly coupled to the angle channel;
the angle channel extending away from the exit aperture;
the angle channel configured to house a buoyant object;
the buoyant object being reversibly disposable into the exit channel from the angle channel as a function of water and oil levels in the tank; and,
the exit channel being configured to be arranged on an axis substantially orthogonal to the gravity vector.

2. The valve of claim 1, wherein the predetermined angle of the buoyant object angle channel is acute.

3. The valve of claim 1, wherein the exit channel is configured to release water from the tank.

4. The valve of claim 1, wherein a weight force of the buoyant object is configured to equal the buoyance forces of oil.

5. The valve of claim 1, wherein the angle channel further comprises a cap configured to seal a distal end of the angle channel.

6. The valve of claim 1, wherein the proximal end is configured to reversibly couple to the tank

7. The valve of claim 1, wherein the angle channel extends from a portion of the exit channel proximate to the oil tank.

8. The valve of claim 1, wherein the buoyant object is configured to block oil from being released from the tank.

9. The valve of claim 1, wherein the angle channel is formed integrally with the exit channel.

10. A valve comprising:
a hollow exit channel extending longitudinally along a predetermined path from a proximal end to an exit aperture at a distal end;
an angle channel extending at a predetermined angle Θ from the exit channel;
the exit channel being fluidly coupled to the angle channel;
the angle channel extending away from the exit aperture; and,
means for controlling flow of fluid through the exit channel positioned in the angle channel;
wherein the means for controlling flow of fluid through the exit channel is reversibly releasable into the exit channel from the angle channel as a function of water and oil levels.

11. The valve of claim 10, wherein the angle channel extends towards the exit aperture.

12. The valve of claim 10, wherein the predetermined angle of the angle channel is 45 degrees.

13. The valve of claim 10, wherein the exit channel is configured to release water from the tank.

14. The valve of claim 10, wherein a weight force of the means for controlling flow of fluid through the exit channel is configured to equal the buoyance forces of oil.

15. The valve of claim 10, wherein the angle channel further comprises a cap configured to seal a distal end of the angle channel.

16. The valve of claim 10, wherein the angle channel extends radially from the exit channel.

17. The valve of claim 10, wherein the angle channel extends from a portion of the exit channel proximate to the tank.

18. The valve of claim 10, wherein the means for controlling flow of fluid through the exit channel is configured to block oil from being released from the tank.

19. The valve of claim 10, wherein the angle channel is formed integrally with the exit channel

20. A method comprising:
providing an tank preparation module having an tank and a valve;
the valve comprising:
a hollow exit channel extending longitudinally along a predetermined path from a proximal end to an exit aperture at a distal end;
an angle channel extending at a predetermined angle Θ from the exit channel;
the exit channel being fluidly coupled to the angle channel;
the angle channel extending away from the exit aperture;
the angle channel configured to house a buoyant object; and,
the buoyant object being configured to reversibly release into the exit channel from the angle channel as a function of water and oil levels in the tank;
determining if a water release mode should be activated;
activating the water release mode to release water from the tank through the valve; and,
disposing the buoyant object into the exit channel from the angle channel.
